(19) United States
(12) Patent Application Publication
(10) Pub. No.: US 2009/0313184 A1
(43) Pub. Date: Dec. 17, 2009

(54) METHOD OF COMMUNITY SERVICE AND DISASTER RELIEF

(76) Inventor: James H. Johnson, JR., Lexington, KY (US)

Correspondence Address: KING & SCHICKLI, PLLC, 247 NORTH BROADWAY, LEXINGTON, KY, 40507, US

(21) Appl. No.: 11/996,685

(22) PCT Filed: Jul. 24, 2006
(86) PCT No.: PCT/US06/28500

§ 371 Date: Jan. 24, 2008

Related U.S. Application Data
(60) Provisional application No. 60/702,476, filed on Jul. 26, 2005.
(60) Provisional application No. 60/727,136, filed on Oct. 14, 2005.
(60) Provisional application No. 60/782,951, filed on Mar. 16, 2006.

(51) Int. Cl. G06F 17/00; G09F 25/00

(52) U.S. Cl. 705/500; 340/286.01

(57) ABSTRACT

A method of community service includes the steps of establishing a network of structures holding emergency relief supplies in anticipation of a possible disaster, equipping the structures with electronic display devices and displaying an emergency message on the electronic display devices in event of an actual disaster.

This application claims the benefit of U.S. provisional application Ser. Nos. 60/702,476 filed on 26 Jul. 2005, 60/727,136 filed on 14 Oct. 2005 and 60/782,951 filed on 16 Mar. 2006.

### TECHNICAL FIELD

The present invention relates to the fields of public service and disaster relief.

### BACKGROUND OF THE INVENTION

Recent events including, particularly, the catastrophic destruction of New Orleans by Hurricane Katrina have highlighted a need for the establishment of emergency relief provision storage facilities in and around “at risk” population centers. Significantly, roads may be partially blocked or impassable following a disaster. Not only does this greatly limit or prevent people in need from reaching emergency supplies, it also greatly limits or prevents a relief agency from efficiently delivering emergency supplies to the people. As a consequence, it is clear that relief supplies need to be in place at the local level in anticipation of a disaster event. Only then is it possible to distribute supplies into the hands of people in need in the immediate aftermath of a disaster.

### SUMMARY OF THE INVENTION

In accordance with the present invention, a method of community or public service is provided. That method comprises the steps of establishing a network of structures holding emergency relief supplies in anticipation of a possible disaster, equipping the structures with electronic display devices and displaying an emergency message on the electronic display devices in event of an actual disaster. The method further includes equipping the structures with emergency power sources for the electronic display devices. Further the method includes remotely controlling programming on the electronic display devices. The method may also include the displaying of an Amber Alert or other public service message on the electronic display devices.

Still further, the method may include advertising on the electronic display devices and generating revenue from that display of advertising. Further the method may include sharing that revenue with a disaster relief organization. In addition the method may include equipping the structures with a radio transmitter and transmitting a public service message or Amber Alert message over the radio transmitter. In addition the method may include transmitting advertising over the radio transmitter.

In accordance with an additional aspect of the present invention, a method of community service comprises establishing a network of structures holding emergency relief supplies in anticipation of a possible disaster, equipping the structures with a radio transmitter and transmitting an emergency message over the radio transmitter in event of an actual disaster. Still further, the method includes an emergency relief structure comprising a housing including an enclosure and an access door, a radio transmitter carried on the housing for broadcasting emergency relief information in event of a disaster and an emergency power source for the radio transmitter. Still further, the emergency relief structure may comprise a housing including an enclosure and an access door, an electronic display device carried on the housing for broadcasting emergency relief information in event of a disaster and an emergency power source for the electronic display device. Emergency relief supplies are stored or held in that housing. The relief supplies may be stored long term in the structure. Alternatively, the structure may be maintained empty and emergency relief supplies may only be moved into the structure when, for example, a disaster, such as a hurricane, is imminent.

The following is a detailed description of the invention. It should be realized, however, that this is just one possible embodiment of the invention and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of this specification, illustrates several aspects of the present invention and together with the description serves to explain certain principles of the invention. In the drawing:

FIG. 1 is a perspective view of an emergency relief supply staging and/or storage structure; and

FIG. 2 is a schematical end elevational view of the structure of FIG. 1 through the open end doors.

### DETAILED DESCRIPTION OF THE INVENTION

In accordance with the present invention, a method of public or community service is provided. That method may be broadly defined as including the steps of establishing a network of structures holding emergency relief supplies in anticipation of a possible disaster, equipping the structures with electronic display devices and displaying an emergency message on the electronic display devices in event of an actual disaster. Still further, the method may include equipping the structures with emergency power sources for the electronic display devices. In addition the method may include remotely controlling programming on the electronic display devices. This allows one to display an Amber Alert message or other public service on the electronic display devices when desired.

Still further, the method may include advertising on the electronic display devices. This allows one to generate revenue from displaying advertising. Some of that revenue may be shared with a disaster relief organization if desired.

In accordance with additional aspects of the present invention, a method of community service comprises establishing a network of structures holding emergency relief supplies in anticipation of a possible disaster, equipping the structure with a radio transmitter and transmitting an emergency message over the radio transmitter in the event of an actual disaster. Such structures may also be equipped with emergency power sources for the radio transmitters. The method may also include remotely controlling the programming over the radio transmitters so that one may transmit a pubic service message, an Amber Alert message or advertising over the radio transmitters as desired. Significantly, the message or image may be programmed for viewing on any or all the electronic display devices in the network in “real time.” As such, the invention provides a very flexible and effective public service and advertising medium.

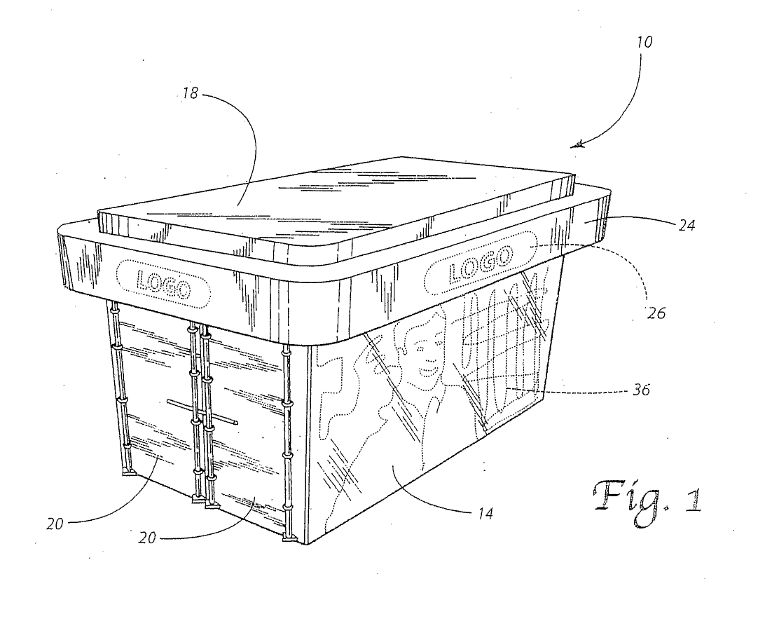

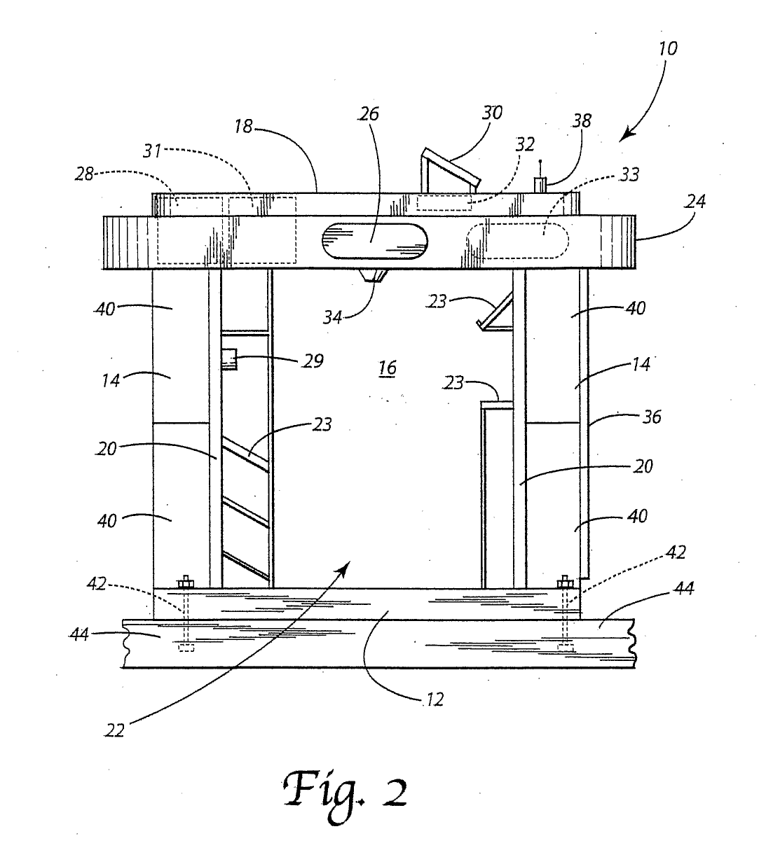

One possible construction of an emergency relief supply staging and/or storage structure 10 is illustrated in FIGS. 1-2. More specifically, the structure 10 includes a floor 12, two side walls 14, an end wall 16 and a roof 18. A pair of cooperating, locking doors 20 define a second end wall opposite the first end wall 16. Any type of door 20 useful for the intended purpose may be utilized. Together, the floor 12, side walls 14, end walls 16, roof 18 and doors 20 define an interior space 22. That space 22 may be customized to meet needs for storing or staging emergency relief supplies such as water, food, baby formula, diapers, first aid kits, medicine, blankets, tents, bedding, communications equipment such as walkie talkies and satellite telephones, and the like.

Similarly, the exterior of the structure 10 may be customized to match the trade dress of substantially any desired party and/or architectural features of any building near which the structure 10 may be placed into service. Thus, for example, the structure 10 may include a decorative roof cap 24 sized and shaped to a user's specifications. The roof cap 24 may include advertising, trade dress or logo 26 if desired and/or as allowed by local regulations.

The structure 10 may also be equipped with various electrical and/or mechanical systems. For example, a climate control unit 28 such as an air conditioner, refrigerator or freezer may be provided on the structure 10 in order to provide climate control of a portion or all of the space 22 within the storage structure. For example, bottled water may be stored in an air conditioned or refrigerated unit. Ice may be stored in a structure 10 equipped with a freezer unit.

In addition, the structure 10 may be equipped with a solar panel 30 and cooperating battery 32 to store energy for powering an internal lighting system 34 for illuminating the space 22. Still further, the structure may include an emergency power source such as an electric generator 31 run by an internal combustion engine, natural gas, propane or even a fuel cell. Such a power source could be used to power a radio transmitter 33, a speaker system or the like provided on the structure to broadcast an emergency message. Such a message could include, for example, directions to the nearest tent city or emergency relief resupply station.

The structure 10 may be constructed, for example, from modular building materials such as prefabricated panels 40 of the type shown and described in, for example, U.S. Pat. Nos. 6,279,287 to Meadows, 5,373,678 to Hesser and 6,119,427 to Wyman et al. Such modular panels 40 typically incorporate a core of thermal insulating material sandwiched between metal or plastic sheathing. Such a construction provides both efficient and effective control of the temperature and humidity of the environment in the internal space 22 and excellent inclement weather durability for a long, low-maintenance service life. Structures 10 constructed from such modular building panels 40 are also characterized by high strength and will resist high winds and maintain a weather-tight enclosure to protect products held in the space 22 from inclement weather. In fact, such structures may be easily anchored to the ground such as by means of cooperating nut and bolt anchors 42 where the bolt is received and held in an underlying poured concrete pad 44. Such structures may be specifically designed to withstand winds associated with Category 3, Category 4 or even Category 5 hurricanes as desired. The modular panels 40 also allow the structure 10 to be quickly and easily erected and subsequently removed in a minimal amount of time while producing a minimum of mess.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the door 20 may be provided in the side wall 16 rather than the end wall. Further, more than one set of doors 20 may be provided if desired. The structure could also include a tap connected to the public water supply. Still further, the structure could include a toilet and a shower connected to the public water supply and waste lines.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A method of community service, comprising:
establishing a network of structures holding emergency relief supplies in anticipation of a possible disaster;
equipping said structures with electronic display devices; and
displaying an emergency message on said electronic display devices in event of an actual disaster.

2. The method of claim 1 including equipping said structures with emergency power sources for said electronic display devices.

3. The method of claim 1, including remotely controlling programming on said electronic display devices.

4. The method of claim 1, including displaying an Amber Alert message on said electronic display devices.

5. The method of claim 1, including displaying a public service message on said electronic display devices.

6. The method of claim 1 including displaying advertising on said electronic display devices.

7. The method of claim 6, including generating revenue from displaying said advertising.

8. The method of claim 7, including sharing said revenue with a disaster relief organization.

9. The method of claim 1, including equipping said structures with a radio transmitter.

10. The method of claim 9, including transmitting a public service message over said radio transmitter.

11. The method of claim 9, including transmitting an Amber Alert message over said radio transmitter.

12. The method of claim 9, including transmitting advertising over said radio transmitter.

13. A method of community service, comprising:
establishing a network of structures holding emergency relief supplies in anticipation of a possible disaster;
equipping said structure with a radio transmitter; and
transmitting an emergency message over said radio transmitter in event of an actual disaster.

14. The method of claim 13, including equipping said structures with emergency power sources for said radio transmitters.

15. The method of claim 13, including remotely controlling programming over said radio transmitters.

16. The method of claim 15, including transmitting a public service message over said radio transmitters.

17. The method of claim 15, including transmitting an Amber Alert message over said radio transmitters.

18. The method of claim 15, including transmitting advertising over said radio transmitters.

19. An emergency relief structure, comprising:
a housing including an enclosure and an access door;
emergency relief supplies held in said enclosure;
a radio transmitter carried on said housing for broadcasting emergency relief information in event of a disaster; and
an emergency power source for said radio transmitter.

20. An emergency relief structure, comprising:
a housing including an enclosure and an access door;
emergency relief supplies held in said enclosure;
an electronic display device carried on said housing for broadcasting emergency relief information in event of a disaster; and
an emergency power source for said electronic display device.
